(19) United States
(12) Patent Application Publication
(10) Pub. No.: US 2005/0088477 A1
(43) Pub. Date: Apr. 28, 2005

(54) Features in substrates and methods of forming

(76) Inventors: Barbara Horn, Eugene, OR (US); Keith Kirby, Albany, OR (US); Mehrgan Khavari, Corvallis, OR (US); Rio T. Rivas, Corvallis, OR (US); Deanna J. Bergstrom, Corvallis, OR (US); Shen Buswell, Monmouth, OR (US); Gerald G. Trunk, Monmouth, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/694,145

(22) Filed: Oct. 27, 2003

(51) Int. Cl. B41J 2/175

(52) U.S. Cl. 347/20

(57) ABSTRACT

The described embodiments relate to features in substrates and methods of forming same. One exemplary embodiment includes a substrate for supporting overlying layers. The embodiment also includes at least one feature formed in the substrate, the feature being formed with at least a first substrate removal process and a second different substrate removal process.

### BACKGROUND

Micro electro mechanical systems devices such as fluid-ejecting devices are employed in various capacities including print cartridges. Many micro electro mechanical systems devices utilize substrates having features formed therein. Features can include both blind features and through features. Features can be formed utilizing various suitable substrate removal techniques. Many of the substrate removal techniques inadvertently can create debris on the substrate proximate the feature and/or can create regions of substrate material prone to cracking. As such a need exists for improved feature forming techniques.

### BRIEF DESCRIPTION OF THE DRAWINGS

The same components are used throughout the drawings to reference like features and components wherever feasible. Alphabetic suffixes are utilized to designate different embodiments.

FIG. 1 illustrates a front elevational view of a diagrammatic representation of an exemplary printer in accordance with one exemplary embodiment.

FIG. 2 illustrates a perspective view of a diagrammatic representation of a print cartridge suitable for use in the exemplary printer shown in FIG. 1 in accordance with one exemplary embodiment.

FIG. 3 illustrates a diagrammatic representation of a side-sectional view of a portion of the print cartridge shown in FIG. 2 in accordance with one exemplary embodiment.

FIGS. 4a-4h illustrate diagrammatic representations of process steps for forming an exemplary slotted substrate in accordance with one embodiment.

FIGS. 5-5a illustrate diagrammatic representations of process steps for forming an exemplary slotted substrate in accordance with one embodiment.

FIGS. 6-6b illustrate diagrammatic representations of process steps for forming an exemplary slotted substrate in accordance with one embodiment.

FIGS. 7-7d illustrate diagrammatic representations of process steps for forming an exemplary slotted substrate in accordance with one embodiment.

FIGS. 8a-8c illustrate diagrammatic representations of process steps for forming an exemplary slotted substrate in accordance with one embodiment.

FIGS. 9a-9b illustrate diagrammatic representations of process steps for forming an exemplary blind feature in a substrate in accordance with one embodiment.

### DETAILED DESCRIPTION OF THE PREFERRED EMBODIMENTS

The embodiments described below pertain to methods and systems for forming features in a substrate. Several embodiments are provided below where the features comprise fluid-handling slots (“slots”). These techniques can equally be applicable to other types of features formed into a substrate.

Slots can be formed in a substrate utilizing a combination of two or more production techniques for selective removal of substrate material. Suitable production techniques include, among others, etching, laser machining, abrasive jet machining, sawing, drilling and/or any combination thereof.

In some embodiments a first production technique is utilized to form a portion of a slot and at least a second, different, production technique is utilized to remove additional substrate material to form a desired slot configuration which is less prone to cracking.

In some embodiments the second, which in some instances is the final removal technique can remove debris produced as a byproduct of the first or previous removal process. Debris can comprise various materials such as processed substrate material and/or byproducts of processed substrate material which remains on the substrate from a substrate removal process.

Slotted substrates can be incorporated into fluid ejection systems such as ink jet print cartridges and/or various micro electro mechanical systems (MEMS) devices, among other uses. The various components described below may not be illustrated to scale. Rather, the included figures are intended as diagrammatic representations to illustrate to the reader various inventive principles that are described herein.

Exemplary Printing Device

FIG. 1 shows a diagrammatic representation of an exemplary printing device that can utilize an exemplary print cartridge. In this embodiment the printing device comprises a printer 100. The printer shown here is embodied in the form of an inkjet printer. The printer 100 can be capable of printing in black-and-white and/or color. The term “printing device” refers to any type of printing device and/or image forming device that employs slotted substrate(s) to achieve at least a portion of its functionality. Examples of such printing devices can include, but are not limited to, printers, facsimile machines, and photocopiers. In this exemplary printing device the slotted substrates comprise a portion of a print head which is incorporated into a print cartridge, an example of which is described below.

Beyond the printing arena, exemplary substrates having features formed therein can be incorporated into various MEMS devices. MEMS devices can comprise fluid-ejecting devices which are utilized in medical and laboratory applications among others. Exemplary substrates also can be utilized in various other applications. For example, display devices may comprise features formed into a glass substrate to create a visual display.

Exemplary Products and Methods

FIG. 2 shows a diagrammatic representation of an exemplary print cartridge 202 that can be utilized in an exemplary printing device. The print cartridge is comprised of a print head 204 and a cartridge body 206 that supports the print head. Though a single print head 204 is employed on this print cartridge 202 other exemplary configurations may employ multiple print heads on a single cartridge.

Print cartridge 202 is configured to have a self-contained fluid or ink supply within cartridge body 206. Other print cartridge configurations may alternatively or additionally be configured to receive fluid from an external supply. Other exemplary configurations will be recognized by those of skill in the art.

Reliability of print cartridge 202 is desirable for proper functioning of printer 100. Further, failure of print cartridges during manufacture increases production costs. Print cartridge failure can be brought about by a failure of the print cartridge components. Such component failure can be caused by cracking. As such, various embodiments described below can provide print heads with a reduced propensity to crack.

Reliability of print cartridges also can be affected by contaminants interfering with or occluding proper fluid (ink) flow. One source of contaminants is debris created during the slotting process. As such, various embodiments described below can provide print heads with a reduced incidence of failure due to inadequate ink flow.

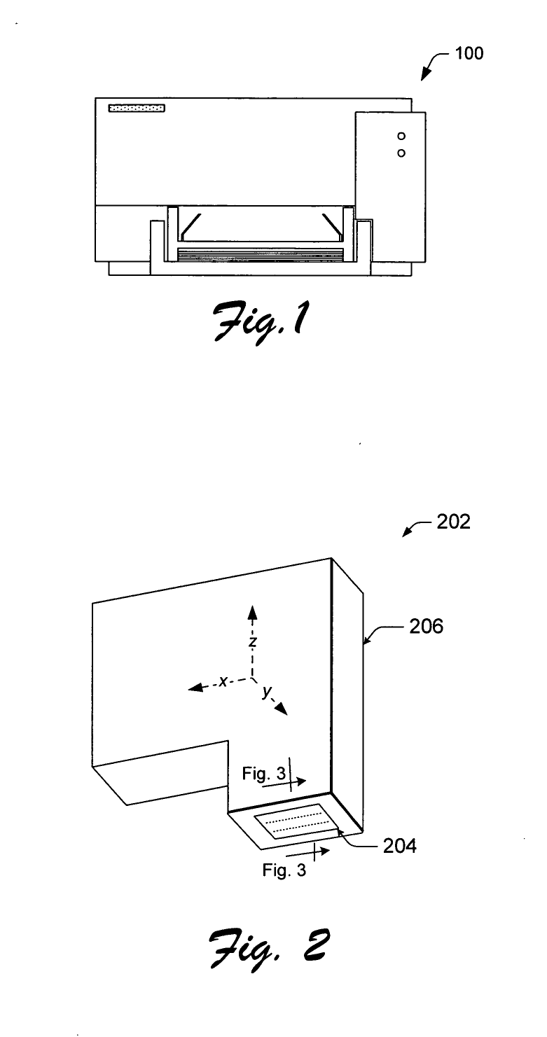

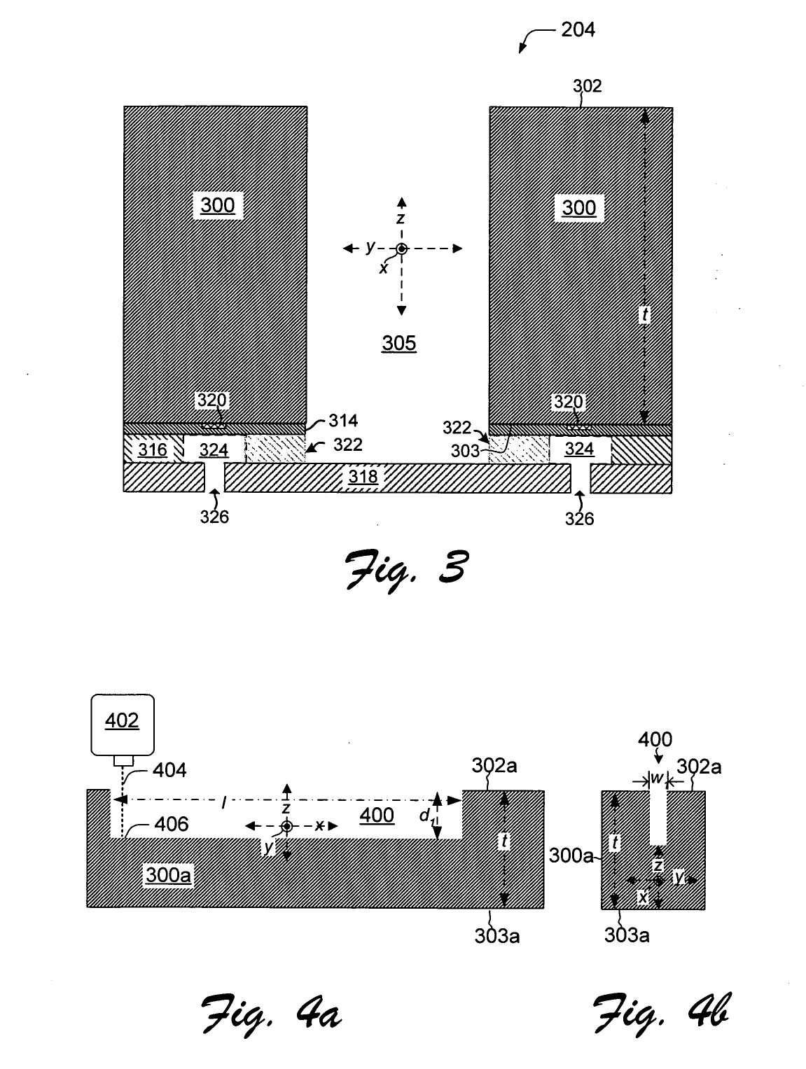

FIG. 3 shows a side-sectional diagrammatic representation of a portion of the exemplary print head 204, taken along line 3-3 in FIG. 2. The view of FIG. 3 is taken transverse an x-axis of a fluid-feed slot (described below), the axis extending into and out of the plane of the page upon which FIG. 3 appears. Here a substrate 300 has a thickness t which extends between a first substrate surface (“first surface”) 302 and a second substrate surface (“second surface”) 303. As will be described in more detail below, forces experienced by the substrate 300 during processing and operating can be concentrated in and around the substrate material proximate first surface 302. Some of the described embodiments can reduce stress concentrations within particular regions of the substrate material, notably those in and around the substrate material proximate first surface 302.

In this embodiment a slot 305 passes through substrate 300 between first and second surfaces 302, 303. As will be described in more detail below, some slot formation techniques inadvertently can produce debris on the substrate material defining slot 305 and/or on the first and second surfaces 302, 303. Such debris can be carried by fluid into the finished print head and cause diminished performance. Some of the described embodiments can remove such debris.

In this particular embodiment, substrate 300 comprises silicon which either can be doped or undoped. Other substrate materials can include, but are not limited to, gallium arsenide, gallium phosphide, indium phosphide, glass, quartz or other material.

Substrate thickness t can have any suitable dimensions that are appropriate for an intended application. In some embodiments substrate thicknesses t can range from less than 100 microns to more than 2000 microns. One exemplary embodiment can utilize a substrate that is approximately 675 microns thick. Though a single substrate is discussed herein, other suitable embodiments may comprise a substrate that has multiple components during assembly and/or in the finished product. For example, one such embodiment may employ a substrate having a first component and a second sacrificial component which is discarded at some point during processing.

In this particular embodiment, one or more thin-film layers 314 are positioned over substrate's second surface 303. In at least some embodiments a barrier layer 316 and an orifice plate or orifice layer 318 are positioned over the thin-film layers 314.

In one embodiment one or more thin-film layers 314 can comprise one or more conductive traces (not shown) and electrical components such as resistors 320. Individual resistors can be controlled selectively via the electrical traces. Thin-film layers 314 also can define in some embodiments, at least in part, a wall or surface of multiple fluid-feed passageways 322 through which fluid can pass. Thin-film layers 314 can also comprise among others, a field or thermal oxide layer. Barrier layer 316 can define, at least in part, multiple firing chambers 324. In some embodiments fluid-feed passageways 322 may be defined in barrier layer 316, alone or in combination with thin-film layers 314. Orifice layer 318 can define multiple firing nozzles 326. Individual firing nozzles can be aligned respectively with individual firing chambers 324.

Barrier layer 316 and orifice layer 318 can be formed in any suitable manner. In one particular implementation both barrier layer 316 and orifice layer 318 comprise thick-film material, such as a photo-imagable polymer material. The photo-imagable polymer material can be applied in any suitable manner. For example, the material can be “spun-on” as will be recognized by the skilled artisan.

After being spun-on, barrier layer 316 then can be patterned to form, at least in part, desired features such as passageways and firing chambers therein. In one embodiment patterned areas of the barrier layer can be filled with a sacrificial material in what is commonly referred to as a ‘lost wax’ process. In this embodiment orifice layer 318 can be comprised of the same material as the barrier layer and can be formed over barrier layer 316. In one such example orifice layer material is ‘spun-on’ over the barrier layer. Orifice layer 318 then can be patterned as desired to form nozzles 326 over respective chambers 324. The sacrificial material then is removed from the barrier layer's chambers 324 and passageways 322.

In another embodiment, barrier layer 316 comprises a thick-film, while the orifice layer 318 comprises an electroformed nickel or other suitable metal material. Alternatively the orifice layer can be a polymer, such as “Kapton” or “Oriflex”, with laser ablated nozzles. Other suitable embodiments may employ an orifice layer which performs the functions of both a barrier layer and an orifice layer.

In operation a fluid, such as ink, can enter slot 305 from the cartridge body shown FIG. 2. Fluid then can flow through individual passageways 322 into an individual chamber 324. Fluid can be ejected from the chamber when an electrical current is passed through an individual resistor 320. The electrical current can heat the resistor sufficiently to heat some of the fluid contained in the firing chamber to its boiling point so that it expands to eject a portion of the fluid from a respectively positioned nozzle 326. The ejected fluid then can be replaced by additional fluid from passageway 322.

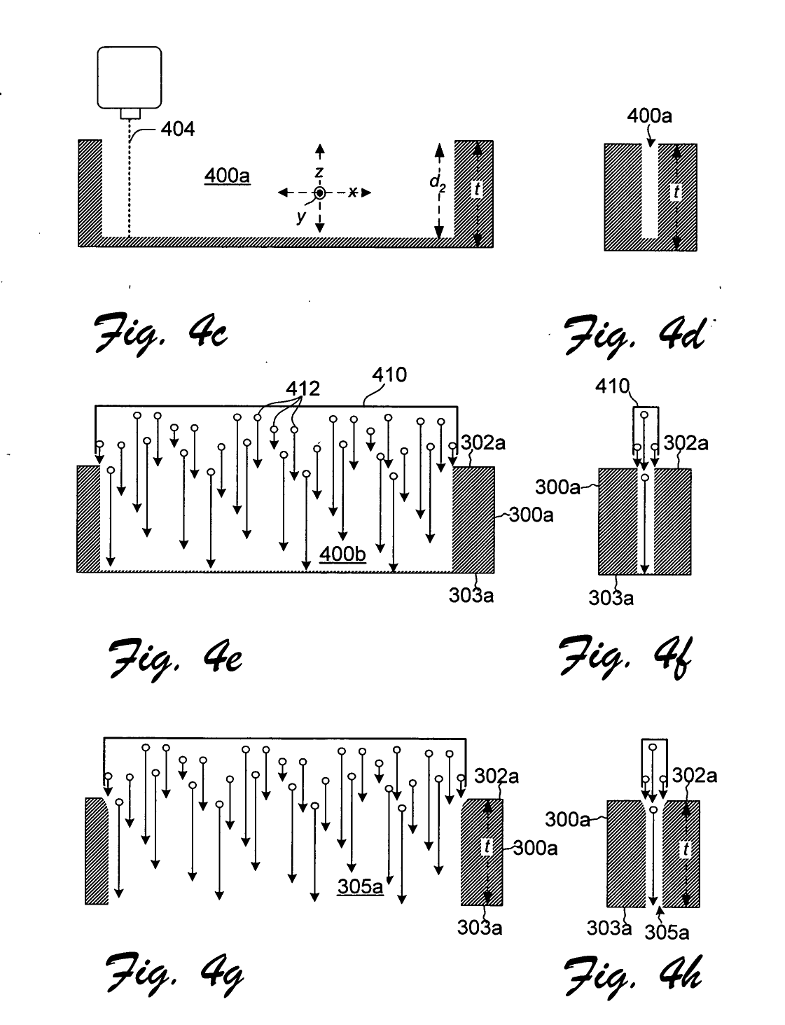

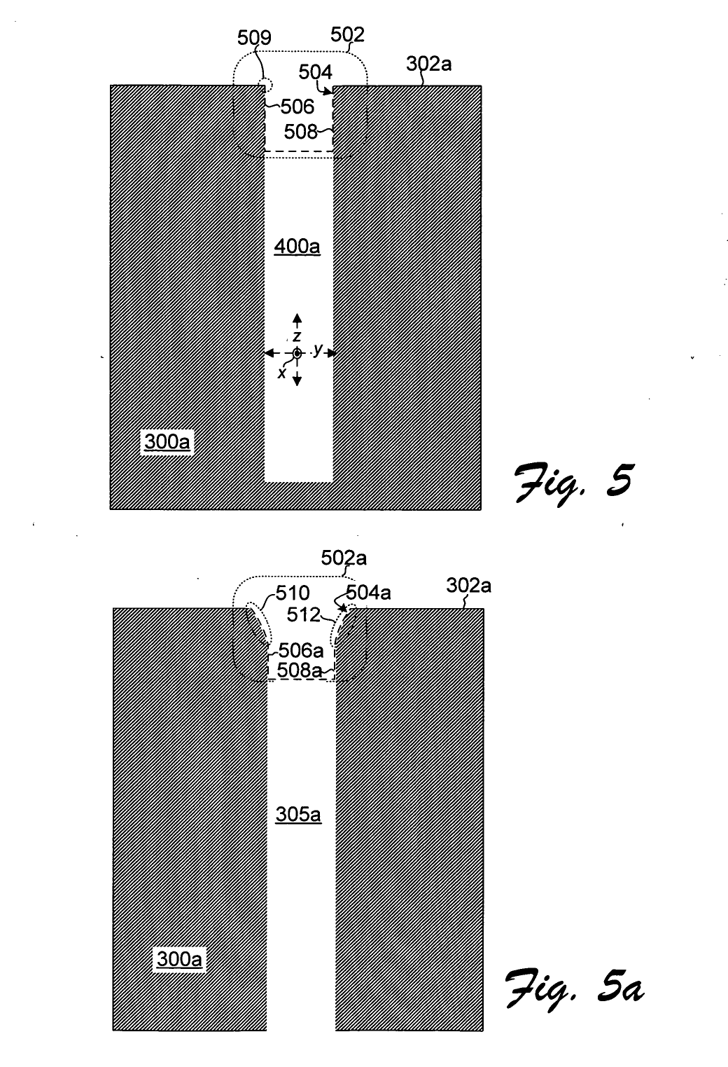

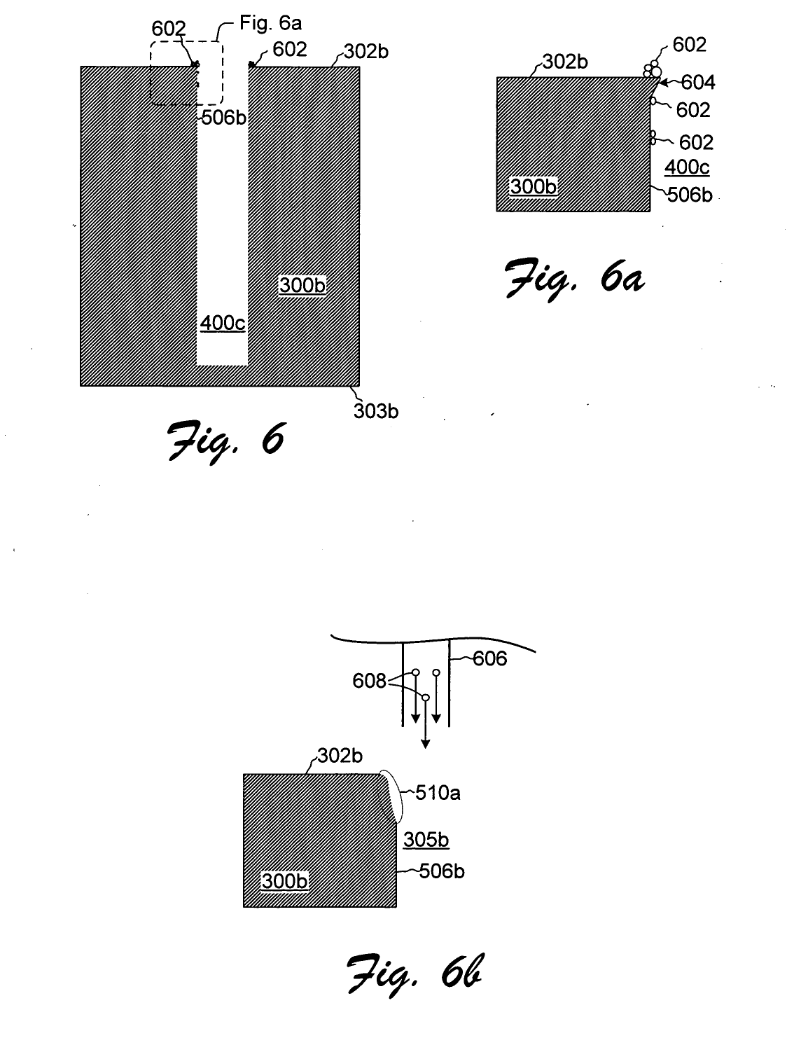

FIGS. 4a-4h show diagrammatic representations of process steps for forming an exemplary slotted substrate and constitute side-sectional views of a substrate 300a. More specifically, FIGS. 4a-4d show a first exemplary substrate removal process or technique. FIGS. 4e-4h show another exemplary substrate removal process which in combination with the first removal process can form a slotted substrate.

FIGS. 4a-4b show a feature 400 formed in substrate 300a utilizing a first substrate removal technique. FIG. 4a represents a view along the x-axis, while FIG. 4b represents a view transverse the x-axis. Various suitable substrate removal techniques may comprise the first removal technique. For example, etching, laser machining, mechanical abrading such as sawing, drilling and abrasive sand machining may be utilized.

Etching can comprise anisotropic etching and/or isotropic etching, or a combination thereof. In one suitable embodiment etching can comprise alternating acts of etching and passivating to achieve a desired etch profile through the substrate. Sawing can utilize a circular saw to mechanically remove substrate material sufficient to form a slot. In some implementations sawing comprises rotating a circular saw blade around an axis of rotation which is generally parallel to a first substrate surface. Drilling mechanically can remove substrate material by rotating a drill bit around an axis of rotation which is generally orthogonal to the first surface.

In the embodiment depicted in FIG. 4a, a laser machine 402 is positioned above substrate 300a. As shown here laser machine 402 emits a laser beam 404 directed at the substrate's first surface 302a to remove substrate material to define a feature 400 having a width w, a length l and a depth d₁ in substrate 300a. In various embodiments, width w₁ can range from less than about 40 microns to more than about 300 microns with one embodiment employing a width w₁ of about 60 microns. Features of any desired length l can be formed utilizing various exemplary embodiments, with some lengths exceeding 1.0 inches.

In this embodiment laser machine 402 is positioned above first surface 320a so that laser beam 404 is emitted from a direction sufficient for laser beam 404 to contact first surface 302a before contacting second surface 303a. Laser beam 404 removes substrate material indicated generally at 406 progressively toward second surface 303a. For purposes of clarity, laser machine 402 and laser beam 404 are omitted from FIG. 4b. Any suitable laser machine configured to remove substrate material can be utilized. Among other variants, suitable laser machines may utilize gas and/or liquid assist in the laser machining process.

FIGS. 4c-4d show views similar to FIGS. 4a and 4b respectively, where laser beam 404 has removed additional substrate material. Feature 400a now passes through a greater than 50% of the substrate's thickness t. As represented here, feature 400a now has a depth d₂ along the z-axis that passes through about 90 percent of the thickness t. Other embodiments may utilize the first removal process to a lesser or greater depth d₂ with some embodiments removing from less than 5% of the substrate's thickness t to 100% of the thickness.

FIGS. 4e-4f Illustrate a second different substrate removal technique. In this instance the second removal technique comprises abrasive jet machining with nozzle 410. Other suitable second and subsequent substrate removal techniques may comprise etching, laser machining, mechanical abrading such as sawing, drilling and abrasive sand machining.

Abrasive jet machining directs abrasive particles 412 toward the substrate 300a in a controlled manner to selectively remove substrate material. Abrasive particles 412 remove substrate material to continue forming feature 400b. As illustrated here abrasive particles 412 are directed toward first surface 302a from a direction which contacts the first surface before contacting second surface 303a.

Suitable abrasive particles can include silica, silicon carbide, fused alumina, fused brown alumina, titanium oxide, and cryogenic CO₂ particles or pellets, among others. One suitable embodiment can utilize fused alumina or titanium oxide of about 99% purity. Another suitable embodiment can utilize an abrasive particle comprising about 96% brown alumina fused with about 3.5% titanium oxide. Any suitable particle size can be utilized. For example, particles sizes between 1-300 microns can provide suitable embodiments. Some specific embodiments utilize particles in a range of about 5 microns to about 60 microns, while some of these embodiments utilize particles in the 8 to 30 micron size. Other suitable particle compositions and/or configurations should be recognized by the skilled artisan.

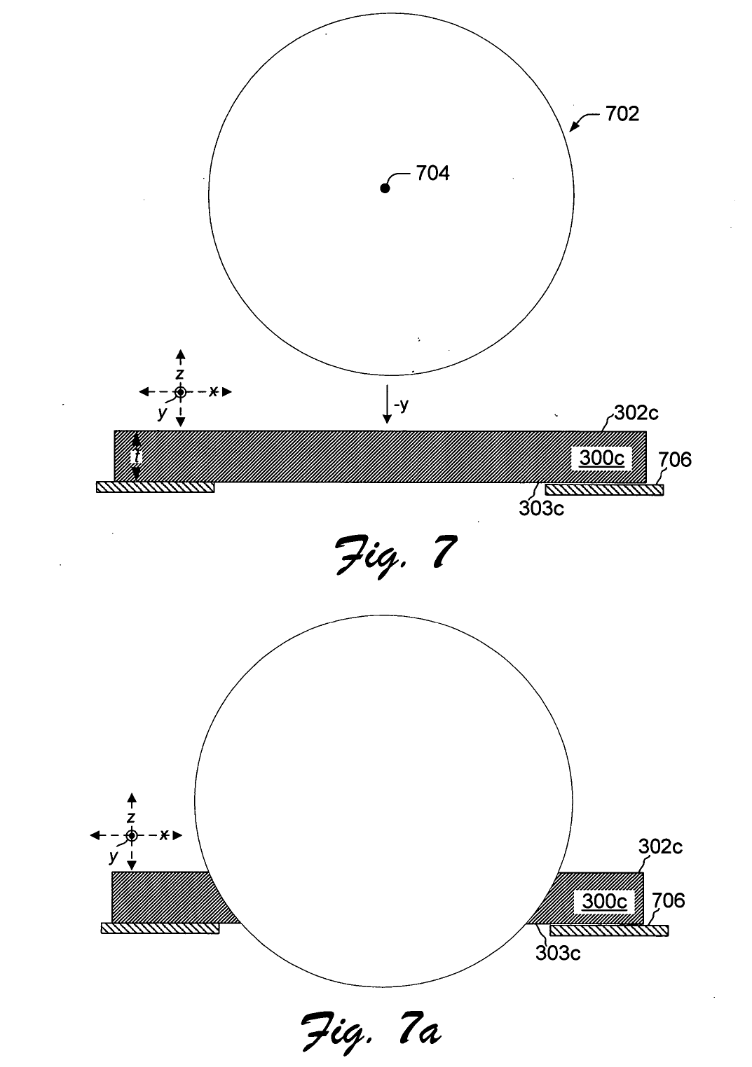

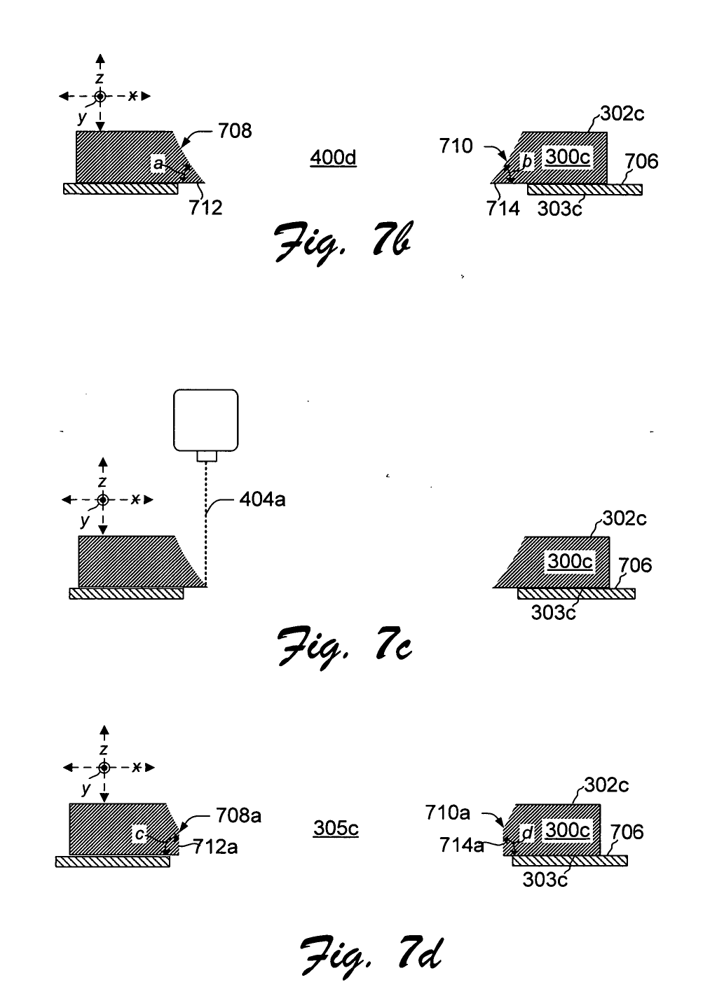

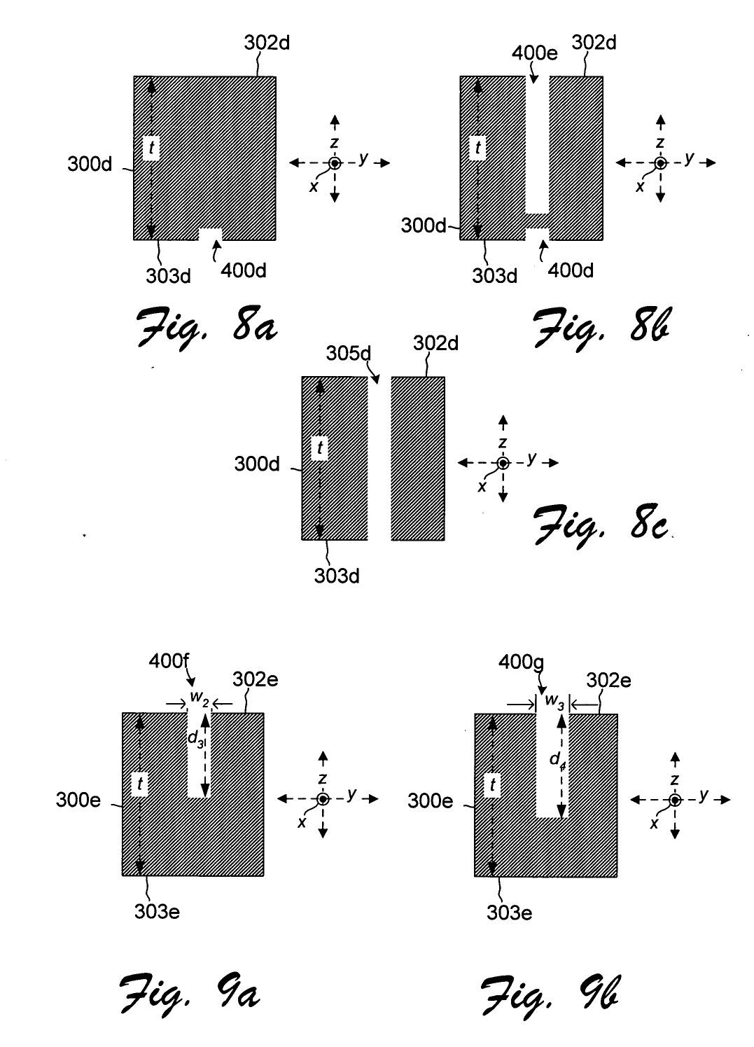

Referring now to FIGS. 4g-4h, abrasive jet machining has removed sufficient substrate so that the feature now comprises a slot 305a which passes through the substrate's entire thickness t. In this instance, abrasive jet machining also affects various properties of the slotted substrate as will be discussed in more detail below in relation to FIGS. 5-5a.

FIG. 5 shows an enlarged view of substrate 300a as shown in FIG. 4d after the first substrate removal process. FIG. 5a shows a similar enlarged view of substrate 300a as shown in FIG. 4h after the second removal process.

FIG. 5 shows an upper terminus 502 of feature 400a. In this instance, upper terminus 502 has a first profile 504 defined, at least in part, by a sidewall that is generally orthogonal to first surface 302a. In this particular instance first profile 504 has two sidewalls 506, 508 that are generally orthogonal to first surface 302a. Substrates that have sidewalls that are orthogonal to the first surface and intersect the first surface at substrate material defining a sharp point or sharp edge can be prone to failure due to cracking. An example of such substrate material is indicated generally at 509. Among other causes, the sharp point or sharp edge defined by sidewall 506 and proximate first surface 302a can be subject to high stress levels. The high stress levels can lead to crack initiation which can then propagate through the substrate 300a resulting in substrate failure.

FIG. 5a shows slot 305a that has upper terminus 502a. In this instance, upper terminus 502a has a second different profile 504a when compared to the representation illustrated in FIG. 5. Second different profile 504a is defined, at least in part by, two sidewalls 506a, 508a. Sidewalls 506a, 508a respectively have a portion 510, 512 that is curvilinear and generally rounds into first surface 302a. Such a configuration can have a reduced propensity to crack in comparison to the configuration shown in FIG. 5. The reduced propensity to crack can be due to, among other factors, spreading out of stress forces experienced at first surface 302a over a greater amount of substrate material.

In addition to achieving a desired slot profile, utilizing at least two substrate removal processes during slot formation can contribute further to the properties of a slotted substrate and subsequently to the quality and reliability of a fluid-ejecting device into which the slotted substrate is incorporated. The discussion of FIGS. 6-6b illustrates but one such example.

FIGS. 6-6a show another exemplary slot forming process. FIG. 6 represents a view of substrate 300b similar to that shown in FIG. 5. FIG. 6a represents an enlarged view of a portion of substrate 300b as indicated in FIG. 6. In this instance a first substrate removal process formed a feature 400c into substrate 300b. The first substrate removal process left debris 602 on substrate 300b.

Debris 602 can hinder proper bonding between components. For example, bonding between a slotted substrate and a cartridge body can be hindered by debris. Alternatively or additionally, debris 602 can hinder integration of the slotted substrate into a functional fluid-ejecting device such as a print head, among others. Such debris can comprise, at least in part, substrate material which was removed incompletely from and/or redeposited on the substrate. Debris 602 also can comprise byproducts of the removal process, including but not limited to, physical and/or chemical compounds formed between substrate material and material utilized in the substrate removal process. For example debris may comprise a compound comprising, at least in part, a component supplied by an etchant, such as TMAH, and a component comprising substrate material. In this instance debris 602 is present both on a sidewall 506b defining feature 400c and on the first surface 302b.

Further, in this implementation, the first removal process also left a relatively small region of substrate material 604 proximate first surface 302b that extends away from the adjoining substrate material and into the feature 400c. Substrate material 604 can act as a crack initiation site due to stress concentrations among other factors. Such crack initiation sites can result in failure of the slotted substrate during processing to form a fluid-ejecting device and/or during the functional life of the fluid-ejecting device.

FIG. 6b shows a second exemplary process step for removing additional substrate material to form slot 305b. Here an abrasive jet machine nozzle 606 can project abrasive material such as abrasive particles 608 at the slotted substrate 300b. Abrasive particles 608 can abrade or remove the debris 602 shown in FIGS. 6-6a from substrate 300b. In some embodiments, the composition of the abrasive particle itself contributes to the removal process. For example, where CO₂ pellets are utilized, the pellets sublimate in proximity to the substrate creating a rapid volumetric expansion which can contribute to removing debris.

Further, in some embodiments, the abrasive particles 608 can remove projecting substrate material 604 shown in FIG. 6a and create a more rounded slot profile. An example of a more rounded slot profile is indicated generally in FIG. 6b, where a portion 510a of wall 506b is now generally curvilinear and blends into first surface 302b. Such a slot profile can have a reduced propensity to crack.

In this embodiment, abrasive jet machine nozzle 606 propels abrasive particles 608 toward substrate 300b via pressurized fluid carrying the particles. The fluid imparts motion to the abrasive particles. The fluid also may contribute to the conditioning process by carrying debris 602 away from substrate 300b. In this particular embodiment the fluid comprises air. Other gases also can be utilized in various embodiments to deliver the abrasive particles 608. Other embodiments can utilize a fluid comprising a liquid to propel the abrasive particles toward the substrate. In one such embodiment the liquid can comprise water. In some embodiments the liquid also may comprise a component which reacts with the substrate. In one such example a TMAH and water solution may be utilized with the abrasive particles. In another embodiment a cryogenic liquid can be utilized to deliver the abrasive particles. In such an embodiment the cryogenic liquid rapidly expands after leaving the nozzle and imparts kinetic energy to the abrasive particles. Suitable cryogenic liquids can include, but are not limited to, carbon dioxide (CO₂), nitrogen (N₂), oxygen (O₂) and helium (He).

Some embodiments may change the composition and/or delivery properties of the fluid and/or particles during the removal process. For example, in one implementation, abrasive particles are delivered via a TMAH and water solution at a first pressure. Subsequently abrasive particles are delivered via pressurized water delivered at a second lower pressure. The first pressure quickly can remove substrate material, while the second delivery pressure cleans-up the slot and removes any remaining etchant material and/or debris.

The ability to utilize two or more different substrate removal processes may have other advantages in some implementations. For example a first substrate removal technique can be utilized based on a desired characteristic or characteristics such as a fast substrate removal rate. The second removal process can be selected for its own desired characteristics which may or may not be the same as the first substrate removal process. In one such example where the first process is selected for fast substrate removal, the second process may be selected based on precise, controlled substrate removal to finish the slot to a desired profile. Such a second process may reduce damage done to various layers positioned over the substrate during the removal process.

FIGS. 7-7d illustrate another exemplary slot formation process. These figures represent views similar to the view shown in FIG. 4a. In the implementation shown in FIGS. 7-7b, a circular cutting saw 702 can be utilized in a first removal process. Saw 702 rotates or spins about an axis 704 that extends into and out of the page on which the figures appear and corresponds to the y-axis. During processing, the substrate's second surface 303c is positioned on a fixture 706.

The circular saw is capable of spinning in a clockwise or counterclockwise direction about the axis of rotation. Other suitable embodiments can spin in one direction and reverse to spin in the other direction or a combination thereof. Suitable saws can have a blade comprising diamond grit, or other suitable material. Suitable circular saws can be obtained from Disco and KNS, among others. Exemplary saw blades can have diameters ranging from less than about ¼ of an inch to more than two (2) inches. One particular embodiment uses a saw blade having a diameter of about ½ inch.

Saw 702 can be lowered toward substrate 300c along the y-axis to contact first surface 302c and remove or cut substrate material. Other embodiments also may move saw 702 along substrate 300c along the x-axis to remove additional substrate material.

In this particular implementation, saw 702 passes entirely through portions of the substrate's thickness t as defined between first surface 302c and second surface 303c. Other implementations may pass through less of the substrate's thickness t.

FIG. 7b shows the result of the act of cutting after the saw is removed from the substrate. The act of cutting forms a feature 400d which in this instance comprises a slot. Feature 400d has a first profile when viewed along the x-axis which in this instance comprises the longest axis. In this implementation the first profile is defined, at least in part, by two end walls 708 and 710, each of which is curved along its length. The first profile is defined, at least in part, by substrate material 712, 714 defining acute angles between second surface 303c and individual endwalls 708, 710. The acute angles are indicated generally here as a and b respectively. Substrate material 712, 714 defining the first slot profile can be subject to stress concentrations and resultant cracking.

FIG. 7c shows a second substrate removal process. In this implementation the second substrate removal process comprises laser machining. A laser beam 404a is directed at first surface 302c from a direction that allows the laser beam to contact first surface 302c before contacting 303c. By directing laser beam 404a from such an orientation, substrate 300c does not have to be repositioned during processing.

Some previous technologies required the additional step of repositioning substrate 300c so that first surface 302c was positioned against the substrate and second surface 303c was exposed for processing. Among other considerations, embodiments which direct both removal processes at the substrate from the first surface may reduce processing costs since the substrate does not need to be repositioned for the second removal process.

FIG. 7d shows substrate material removed by the first and second removal processes to form a slot 305c having a desired configuration in substrate 300c. Slot 305c has a second different profile when compared to FIG. 7b. In this instance the second profile comprises two end walls 708a, 710a. Individual end walls 708a, 710a have a portion 712a, 714a respectively which intersects second surface 303c at an angle of about 90 degrees or greater. The angles are indicated generally at c, d. Such an endwall configuration has a reduced propensity to crack when compared to the first profile shown in FIG. 7b.

FIGS. 8a-8c illustrate another exemplary removal process. FIGS. 8a-8c represent cross-sections taken transverse an x-axis similar to the view represented in FIG. 4b. FIG. 8a illustrates a feature 400d formed into second surface 303d. Feature 400d may be formed with any suitable removal technique. In this embodiment feature 400d comprises a relatively shallow feature etched into second surface 303d. Forming feature 400d into the second surface can provide precise relative alignment of the feature on the first surface.

FIG. 8b illustrates a feature 400e formed into first surface 302d. Any suitable substrate removal technique can be utilized to form feature 400e. In this embodiment feature 400e is formed by laser machining. In this embodiment feature 400e extends through a majority of the substrate's thickness t, and laser machining can provide a relatively fast substrate removal rate.

FIG. 8c illustrates additional substrate material removed through first surface 302d sufficient to intersect feature 400d and form a slot 305d through substrate 300d. Any suitable substrate removal technique can be utilized. In this embodiment etching is utilized. Etching can remove debris remaining from the laser machining process and smooth out the slot profile to reduce the potential for cracking of the substrate. This embodiment utilizes three distinct removal processes to form a slot in the substrate. Other embodiments utilizing two distinct removal processes are described above. Other suitable embodiments can utilize more removal processes than the three shown here. Some embodiments may also apply material, such as through deposition, between removal processes. While a slot is shown, the slot is intended to be representative of various feature shapes that can be achieved. The embodiments described above have produced through features which pass through an entirety of a substrate's thickness. FIGS. 9a-9b illustrate an example of how exemplary processes can be applied to form a blind feature.

FIGS. 9a-9b illustrate a further exemplary embodiment. This embodiment forms a blind feature in substrate 300e. Such a process can be useful for many applications. One such application involves forming blind features into a glass substrate for use in a display device.

FIG. 9a forms feature 400f into first surface 302e with a first substrate removal process.

FIG. 9b removes additional substrate material with a second different substrate removal process to produce feature 400g. In some embodiments the second substrate removal process can clean up debris resulting from the first substrate removal process. Alternatively or additionally, the second substrate removal process may change the feature profile and/or feature dimensions. In this particular embodiment feature 400g has a greater width w₃ than feature 400f (w₂) and has a greater depth d₄ as compared to d₃ of feature 400f.

Various representative first and second substrate removal techniques are described above to form features in substrates. Other suitable embodiments can utilize other removal techniques to form features.

The described embodiments can form a slotted substrate. Slots can be formed in a substrate utilizing two more production techniques for selective removal of substrate material to form a desired slot configuration. Some of these production techniques also may condition the substrate to decrease the incidence of substrate failure during processing and/or during use.

Although specific structural features and methodological steps are described, it is to be understood that the inventive concepts defined in the appended claims are not necessarily limited to the specific features or steps described. Rather, the specific features and steps are disclosed as forms of implementation of the inventive concepts.

1. A method comprising:
first removing substrate material with a first process from a substrate to form a feature extending into the substrate and within the substrate along an axis, wherein a cross-section of the feature taken transverse the axis has an upper terminus proximate a first substrate surface, the upper terminus having a first profile; and,
second removing additional substrate material with a second different process sufficiently to cause the upper terminus to have a second profile different from the first profile.

2. The method of claim 1, wherein the first removing and second removing forms the feature comprising a fluid-handling slot extending between the first surface and a generally opposing second surface.

3. The method of claim 1, wherein said first removing forms the first profile defined by sidewalls which are generally orthogonal to the first surface and wherein said second removing forms the second profile being defined, at least in part, by at least one sidewall portion that is rounded into the first surface.

4. The method of claim 1, wherein said first removing comprises directing a laser beam toward the first surface from a direction sufficient to contact the first surface before contacting a generally opposing second surface, and wherein said second removing comprises directing abrasive particles toward the first surface from a direction sufficient to contact the first surface before contacting the second surface.

5. The method of claim 4, wherein said directing abrasive particles also conditions portions of the first surface by removing debris created by said directing a laser beam.

6. A print cartridge formed in accordance with the method of claim 1.

7. A method comprising:
first directing a first removal means at a substrate from a direction sufficient to contact a first surface before contacting a second generally opposite surface; and,
second directing a second removal means at a substrate from a direction sufficient to contact the first surface before contacting the second surface, wherein said first directing and second directing form a feature in the substrate.

8. The method of claim 7, wherein said act of second directing comprises directing the second removal means to mechanically condition at least one of the first surface and one or more walls defining the feature.

9. The method of claim 7, wherein said act of second directing removes debris created by the first removal means.

10. A print cartridge formed in accordance with the method of claim 7

11. A method comprising:
first removing a substrate material through a first substrate surface, with a first removal process, to form a feature in the substrate, the feature being defined, at least in part, by at least one sidewall that is generally orthogonal to the first surface; and,
second removing additional substrate material with a second different removal process, sufficient to form a generally curved region in the at least one sidewall that joins with the first surface.

12. The method of claim 11, wherein upon conclusion of said first removing and second removing the feature comprises a fluid-handling slot through the substrate.

13. The method of claim 11, wherein said first removing substrate material forms a feature defined at the first surface by multiple sidewalls each of which are generally orthogonal to the first surface and wherein said second removing forms the generally curved portion on each of the multiple sidewalls, wherein said second removing also mechanically conditions the substrate by removing debris created by said first removing.

14. The method of claim 11, wherein said first removing extends through an entire thickness of the substrate as defined between the first substrate surface and a second generally opposing substrate surface.

15. The method of claim 11, wherein said first removing comprises etching and the second removing comprises abrasive jet machining.

16. A print cartridge formed in accordance with the method of claim 11.

17. A method comprising:
laser machining a substrate with a laser beam directed toward a first surface of a substrate and from a direction sufficient to contact the first surface before contacting a second generally opposing surface; and,
abrading the substrate, at least in part, to remove debris remaining from the act of laser machining; wherein upon completion of said laser machining and said abrading, sufficient substrate material is removed to form a fluid-handling slot through the substrate.

18. The method of claim 17, wherein said abrading comprises directing abrasive particles toward the first surface in a direction sufficient to contact the first surface before contacting the second surface and wherein said directing removes potential crack initiation sites from the substrate proximate the slot and the first surface.

19. The method of claim 17, wherein said abrading comprises contouring at least a portion of a wall defining the fluid-handling slot.

20. A print cartridge formed in accordance with the method of claim 17.

21. A method of processing a semiconductor substrate comprising:
forming a majority of a fluid-handling slot in a substrate utilizing a first removal process; and,
forming less than a majority of the fluid-handling slot with at least one different removal process which also removes debris remaining from the first removal process.

22. The method of claim 21, wherein said forming less than a majority of the fluid-handling slot removes debris from walls of the slot.

23. The method of claim 21, wherein said forming less than a majority of the fluid-handling slot removes debris from a first surface of the substrate proximate the fluid-handling slot.

24. The method of claim 21, wherein said forming less than a majority of the. fluid-handling slot removes debris from at least one wall of the fluid-handling slot and from a first surface of the substrate proximate the fluid-handling slot.

25. The method of claim 21, wherein said forming less than a majority of the fluid-handling slot creates an upper terminus of the fluid-handling slot that blends into the first surface.

26. A method comprising:
removing a portion of a substrate from a direction sufficient to contact a first surface before contacting a second generally opposite surface using a first process; and,
removing another portion of the substrate from a direction sufficient to contact the first surface before contacting the second surface, wherein said removing the portion and removing the another portion form a feature in the substrate.

27. The method of claim 26, wherein said removing another portion removes debris created by the first removal means.

28. The method of claim 26, wherein said removing another portion comprises mechanically conditioning at least one of the first surface and one or more walls defining the feature.

29. The method of claim 26, wherein the removing a portion and removing another portion forms the feature comprising a fluid-handling slot extending between the first surface and the second surface.

30. The method of claim 26, wherein said removing a portion forms a first feature profile defined by sidewalls which are generally orthogonal to the first surface and wherein said removing another portion forms a second feature profile being defined, at least in part, by at least one sidewall portion that is rounded into the first surface.

31. The method of claim 26, wherein said removing a portion comprises directing a laser beam toward the first surface from a direction sufficient to contact the first surface before contacting the second surface, and wherein said removing another portion comprises directing abrasive particles toward the first surface from a direction sufficient to contact the first surface before contacting the second surface.

32. The method of claim 31, wherein said directing abrasive particles also conditions portions of the first surface by removing debris created by said directing a laser beam.

33. A print cartridge formed in accordance with the method of claim 26.

34. A fluid-ejecting device comprising:
a substrate comprising at least a first substrate surface and a second substrate surface, a fluid-handling slot formed by at least two substrate removal processes and extending through the substrate between the first substrate surface and the second substrate surface; and,
an orifice layer positioned over the first substrate surface, the orifice layer having multiple firing nozzles formed therein, at least some of the nozzles being in fluid flowing relation with the fluid-handling slot, wherein at least one of the first substrate surface and the second substrate surface being mechanically conditioned by at least one of the removal processes prior to the orifice layer being positioned over the first substrate surface, at least in part, to reduce an incidence of debris occluding ink flow through individual nozzles.

35. The fluid-ejecting device of claim 34, wherein the fluid-handling slot is formed utilizing three different substrate removal processes.

36. The fluid-ejecting device of claim 34, wherein the fluid-handling slot is formed utilizing at least one substrate removal process directed at the first substrate surface and at least two different substrate removal processes directed at the second substrate surface.

37. A print cartridge comprising, at least in part, the fluid-ejecting device of claim 34.

38. A micro electro mechanical systems device comprising:
a substrate for supporting overlying layers; and,
at least one feature formed in the substrate, the feature being formed with at least a first substrate removal process and a second different substrate removal process, wherein the second different substrate removal process also removes debris created by the first substrate removal process.
